(19) United States
(12) Patent Application Publication
(10) Pub. No.: US 2023/0086608 A1
(43) Pub. Date: Mar. 23, 2023

(54) OFF-NETWORK MULTIMODAL INTEROPERABLE COMMUNICATIONS

(71) Applicant: Mutualink, Inc., Wallingford, CT (US)

(72) Inventor: Joseph R. MAZZARELLA, Tolland, CT (US)

(73) Assignee: Mutualink, Inc., Wallingford, CT (US)

(21) Appl. No.: 17/932,604

(22) Filed: Sep. 15, 2022

Related U.S. Application Data
(60) Provisional application No. 63/245,738, filed on Sep. 17, 2021.

(51) Int. Cl. H04W 40/02

(52) U.S. Cl. CPC H04W 40/02; H04W 88/06

(57) ABSTRACT

Some embodiments include a first mobile device that is disconnected from a first host wireless network, where the first mobile device creates a first pro se directory that identifies member mobile devices of an off-network multimodal hybrid mesh network that are available for peer-to -peer communications with the first mobile device. A second member mobile device that is disconnected from a second host wireless network can create a corresponding second pro se directory that can be exchanged. Based on the pro se directories, the first mobile device can determine a first proxy communications path to a third mobile device that is not local to the first mobile device, where the third mobile device has access to a third host wireless network. The first mobile device can transmit a message to the third mobile device via the first proxy communications path that utilizes two different wireless technologies.

### CROSS-REFERENCE TO RELATED APPLICATIONS

This application claims the benefit of U.S. Provisional Application No. 63/245,738, titled Off-Network Multimodal Interoperable Communications, filed Sep. 17, 2021, which is incorporated herein by reference in its entirety.

### BACKGROUND

### Field

The embodiments relate generally to off-network communications in a wireless communication system.

### SUMMARY

Some embodiments include an apparatus, method, and computer program product for wireless interoperable communications in an off-network multimodal hybrid mesh network that includes one or more mobile devices. Some embodiments include a first mobile device that is disconnected from a first host wireless network. Based at least on the disconnection, the first mobile device can create a first pro se directory corresponding to the first mobile device that identifies one or more member mobile devices of an off-network multimodal hybrid mesh network that are available for peer-to-peer communications with the first mobile device, where the first mobile device is a member mobile device of the off-network multimodal hybrid mesh network. The first mobile device can transmit the first pro se directory to the one or more member mobile devices, and receive a second pro se directory from a second mobile device of the one or more member mobile devices, where the second mobile device is disconnected from a corresponding second host wireless network.

Based on the first pro se directory and the second pro se directory, the first mobile device can determine a first proxy communications path to a third mobile device that is not local to the first mobile device, where the third mobile device has access to a third host wireless network, and where the first proxy communications path utilizes two or more different wireless technologies. The first mobile device can transmit a first message via the first proxy communications path using a first wireless technology to the second mobile device, where the second mobile device relays the first message via the first proxy communications path using a second wireless technology to the third mobile device.

In some embodiments, the second pro se directory indicates that the third mobile device is in proximity to the second mobile device, and includes a relay status of the second mobile device to relay signals to the third mobile device.

In some embodiments, to create the first pro se directory, the first mobile device can discover one or more local mobile devices available for peer-to-peer communications, and transmit invitations to the one or more local mobile devices to become members of the off-network multimodal hybrid mesh network. In response to the invitations, the first mobile device can receive one or more acceptances corresponding to one or more member mobile devices of the off-network multimodal hybrid mesh network, and create the first pro se directory corresponding to peer-to-peer communication abilities of the first mobile device based at least on the one or more acceptances. The first mobile device can transmit the first pro se directory to the one or more member mobile devices, and receive one or more pro se directories corresponding to the one or more member mobile devices including the second pro se directory.

In some embodiments, the two or more different wireless technologies comprise: Specialized Land Mobile Radio Services (SMR), Advanced Wireless Service (AWS), Broadband Personal Communication Services, (PCS), General Mobile Radio Service (GMRS), Multi-Use Radio Service (MURS), LoRa, Cellular service, Citizens Band Radio Service (CB), Citizens Broadband Radio Service (CBRS), Bluetooth, WiFi, Low-Power Radio Service (LPRS), or Family Radio Service (FRS).

In some embodiments, the first mobile device can determine from a pro se directory corresponding to a fourth mobile device of the one or more member mobile devices, an indication that the fourth mobile device in proximity has access to a third host wireless network. The first mobile device can set a relay status of the first mobile device for relaying signals to the fourth mobile device and the third host wireless network, update the first pro se directory with the indication and the relay status, and transmit the first pro se directory to the one or more member mobile devices. The first mobile device can include a wireless local relay module (LRM), and can receive a second message from a member mobile device of the one or more member mobile devices based on a second proxy communications path. Based at least on the relay status, the first mobile device can transmit the second message via the LRM to the fourth mobile device. In some embodiments, the first mobile device can include a land mobile radio interface where the reception of the second message is via the land mobile radio interface, and where the transmission of the second message utilizes Bluetooth or Wi-Fi.

To transmit the first message via the first proxy communications path using the first wireless technology, the first mobile device can determine based on programmatic rules and algorithms, a first signal strength of the first message where the first signal strength is greater than a signal strength permitted for communications on the first host wireless network, and transmit the first message using the first signal strength. To transmit the first message via the first proxy communications path using the first wireless technology, the first electronic device can also change an antenna direction, an antenna phasing, or an antenna filter. The change can be based on programmatic rules, algorithms and a factor including: a signal strength, proximity or location of the second member mobile device corresponding to the first proxy communications path, or a packet loss rate.

In some embodiments, the first mobile device corresponds to a first identification (UID) that can be transmitted in the first message and relayed along the first proxy communications path, where the first UID is unique and distinct from other UIDs of the one or more member mobile devices. The first mobile device can be associated with one or more other identities that are relationally associated to the UID, wherein the one or more other identities are associated with: the first host wireless network (e.g., a Network ID), an application operating on the first mobile device, a user of the application, or a user of the first mobile device. In some embodiments, the first mobile device can store data in memory, where the data comprises: the UID, the Network ID, a user name, a password, a key, a token, or a network routing address associated with Network ID, the first pro se directory, or one or more pro se directories corresponding to the one or more member mobile devices.

In some embodiments, the first pro se directory includes: a unique identification (UID) of the first mobile; a time, date, and location of the first mobile device; a user identity or network user identity for a distinct network; a routing address or proxy network address to the first mobile device; a data transmission rate; a communications protocol; encryption keys; a signal strength; a battery or power source; an organizational association; an end-user identity; a network host connectivity status including internet access or internet gateway access; or uplink and downlink data rates.

In some embodiments, the first mobile device can receive a second message including updated routing and network connectivity status corresponding to the second pro se directory, update the first pro se directory based on the second message, and transmit a third message including the updated routing and network connectivity status corresponding to the first pro se directory to the one or more member mobile devices. The second message can be transmitted periodically and can be broadcasted.

In some embodiments, the first mobile device can include a graphical user interface (GUI), where the GUI enables a selection that can change signal transmitting power or antenna orientation to maximize a signal strength of the transmission of the first message to the second mobile device.

In some embodiments, the first mobile device can determine locations of the one or more member mobile devices using location algorithms comprising: time difference of arrival, angle of arrival, or geo-position system data received from the one or more member mobile devices. The first mobile device can also determine a movement direction, speed, or anticipated location of the one or more member mobile devices based on a time series or sampling intervals of the determined locations. The first proxy communications path may be based on the determined movement direction, speed, or anticipated location of the one or more member mobile devices. The determined movement direction, speed, or anticipated location of the one or more member mobile devices can be used to affect a direction of an antenna transmitting the first message or affect a transmission power of the first message.

In some embodiments, to determine the first proxy communications path, the first mobile device can determine a priority proxy communications path comprising: a subset of the one or more member mobile devices, an antenna operating configuration, and a signal enhancement configuration based on a set of rules or algorithms. The first mobile device can route through one or more member mobile device relays of the subset based on factors comprising: a common or shared organizational membership, a communications encryption method or scheme, an attention method, an attention scheme, a network membership with the one or more member mobile device relays, a user associated with a member mobile device of the one or more member mobile device relays, or a user of a member mobile device relay of the one or more member mobile device relays, or a wireless network identity. The first message can include a priority message relay that is re-transmitted, relayed, or received at a higher priority over other messages. The first mobile device can determine the priority message relay using a set of rules or algorithms based upon factors including: a message type, a message content, an identity of the first mobile device or the third mobile device, an identity of a first user of the first mobile device or a second user of the third mobile device, or an organizational role or function of the first user or the second user.

### BRIEF DESCRIPTION OF THE FIGURES

The accompanying drawings, which are incorporated herein and form part of the specification, illustrate the presented disclosure and, together with the description, further serve to explain the principles of the disclosure and enable a person of skill in the relevant art(s) to make and use the disclosure.

FIG. 1 illustrates an example system for off-network multimodal interoperable communications, in accordance with some embodiments of the disclosure.

FIG. 2 illustrates a block diagram of an example wireless system supporting off-network multimodal interoperable communications, according to some embodiments of the disclosure.

FIG. 3 illustrates an example method for off-network multimodal interoperable communications, in accordance with some embodiments of the disclosure.

FIG. 4 is an example computer system for implementing some embodiments or portion(s) thereof.

The presented disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some embodiments include a system, method, and computer program product, for achieving off-network mobile telephone to mobile telephone communications with interoperable capability in instances of a lack of host network access using a hybrid mesh routing function with a dynamic shared directory among endpoints.

In disaster environments communications networks, wireless and landline communications networks can be impaired or rendered inoperable due to physical damage and/or loss of power to various network elements including loss of cell towers, antennas, repeaters, routing, application and database servers, switching equipment, and transmission conduits. In these environments, first responders and supporting emergency response entities require effective communications to coordinate activities and share information. In those environments, customary means of emergency communications, such as land mobile radio and mobile network coverage may be nonexistent. Various means exist to quickly reinstate network coverage through mobile cellular network site solutions. These are sometimes referred to as Sites on Wheels (SOWs) or Cells on Wheels (COWs). Additionally, there exist solutions that provide wireless mesh network capabilities that enable various forms point to multipoint communications through as series or collection of transceivers which may be human portable and/or fixed endpoints capable of relaying or routing communications among various endpoints within the local mesh network. In each of the foregoing instances, there are means of interconnecting local communications with other common or private carrier networks through network interconnection points which may be proximate or remote to the local network. However, these mobile solutions require transportation to disaster site locations which involve time and depending on the magnitude and scope of the disaster, there may not be sufficient resources available to meet all needs.

Within the land mobile radio industry, certain radio protocols allow for “pro se” communications capacity where radio unit to radio unit communications can be effectuated in the absence of communications connectivity to the host radio network through radio repeater sites. Due to the unique characteristics of land mobile radio and allocation of dedicated narrowband radio spectrum under prevailing regulatory license frameworks, land mobile radio transceivers are permitted to operate at higher power than commercial mobile cellular and personal communications services transceiver units (5 Watts vs. 1 or 2 Watts). Further, the actual power that a mobile phone transmits is regulated by cellular base stations to the lowest power levels achievable with good quality of service. Consequently, as a generalized matter, putting aside propagation, environmental and antenna topology considerations, and all things being equal, a land mobile radio transceiver unit will transmit signals at a greater distance than cellular counterparts. Thus, it is contended that land mobile radios are preferable to cellular devices in disconnected network environments due to signal transmission power and radio to radio functions.

However, it is becoming appreciated that land mobile radio systems are comparatively expensive compared to mobile applications that operate on mobile devices using 4G, 5G and subsequent generations of broadband wireless networks that can emulate land mobile radio communications behavior. These applications are known as “push to talk” or “PTT” over cellular applications. Further, within the United States, a national first responder network known as “FirstNet” was created to enable and provide first responders with access to dedicated mobile broadband access with priority and preemption over public users using the same mobile network infrastructure. Other mobile network carriers have implemented first responder offerings with priority access ad preemption. These features enable increased network access and reliability for critical first responder communications.

One means of enhancing local coverage to enable two disjunct wireless mobile units with no network connectivity or means to discover each other due to poor signal strength is to employ a high-power user equipment (HPUE) devices that can act as local access point to which each disjunctive unit can connect and messages between such units may be relayed. HPUEs are not distinct devices which must be carried into the field and have an independent installation, making them separate and distinct from the disjunct units. However, an HPUE may be controlled by one or more wireless mobile units either directly through a communications connection or indirectly through an application server controlling an HPUE to which the wireless mobile unit may be connected.

Finally, it is recognized that many smart phones have mobile compute operating systems such as IOS and various Android distributions along with multiple coder-decoders (CODECS) and multiband transceiver capabilities to transmit and receive Wi-Fi, Bluetooth, BLE, and other wireless protocols within authorized radio frequency bands. This may include wireless access point capabilities, often referred to as “hot spots”.

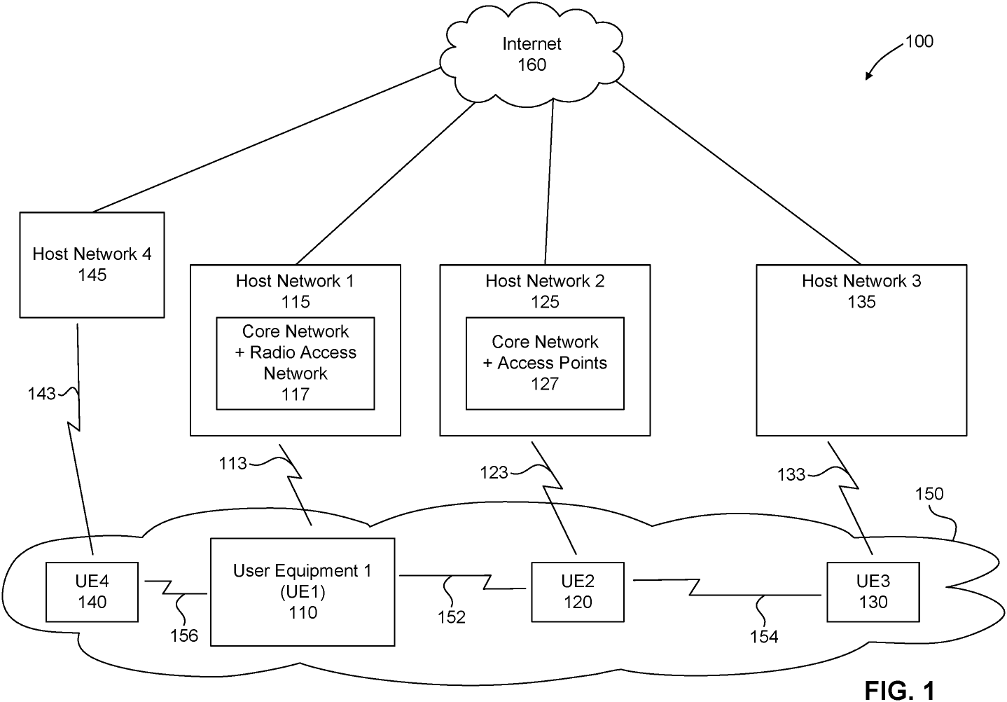

FIG. 1 illustrates example system 100 for off-network multimodal interoperable communications, in accordance with some embodiments of the disclosure. System 100 includes user equipment 1 (UE1) 110 that communicates wirelessly to host wireless network 1 115 via wireless signal 113. Host wireless network1 115 can include core network and radio access network 117. For example, the radio access portion can include base stations and cellular towers supporting celluar communications (e.g., 3G, 4G, 5G technologies) while the core network can include the network elements that enable host wireless network 1 115 to connect and communicate via internet 160. System 100 includes UE2 120 that communicates wirelessly to host wireless network 2 125 via wireless signal 123. Host wireless network 2 125 can include core network and access points 127. For example, the access points can support local area networks (LANs) that can include Wi-Fi technologies, for example. In some examples the core network can include network elements (e.g., of a cable/fiber network or a cellular network) that enable host wireless network 2 125 to connect and communicate via internet 160.

System 100 can also include UE3 130 and UE4 140 that communicate wirelessly to respective host wireless network 3 135 via wireless signal 133 and host wireless network 4 145 via wireless signal 143. Host wireless network 3 135 and/or host wireless network 4 145 can include radio access and system network elements that enable host wireless network 3 135 and/or host wireless network 4 145 to connect and communicate via internet 160.

In some embodiments, host wireless network 1 115, host wireless network 2 125, host wireless network 3 135 and/or host wireless network 4 145 may utilize one or more of the following technologies: Bluetooth, WiFi, LoRa, Cellular service, Broadband Personal Communication Services, (PCS), Specialized Land Mobile Radio Services (SMR), Advanced Wireless Service (AWS), Citizens Band Radio Service (CB), Citizens Broadband Radio Service (CBRS), General Mobile Radio Service (GMRS), Multi-Use Radio Service (MURS), Low-Power Radio Service (LPRS), and/or Family Radio Service (FRS).

In some embodiments, when two or more UE in proximity (e.g., UE1 110 and UE2 120) lose access to their respective host wireless networks (e.g., lose wireless signals 113 and 123, respectively), the two or more UE can establish off-network multimodal hybrid mesh network 150 with UEs in proximity, where off-network multimodal hybrid mesh network 150 enables wireless interoperable communications that may utilize wireless signals 152, 154, and 156.

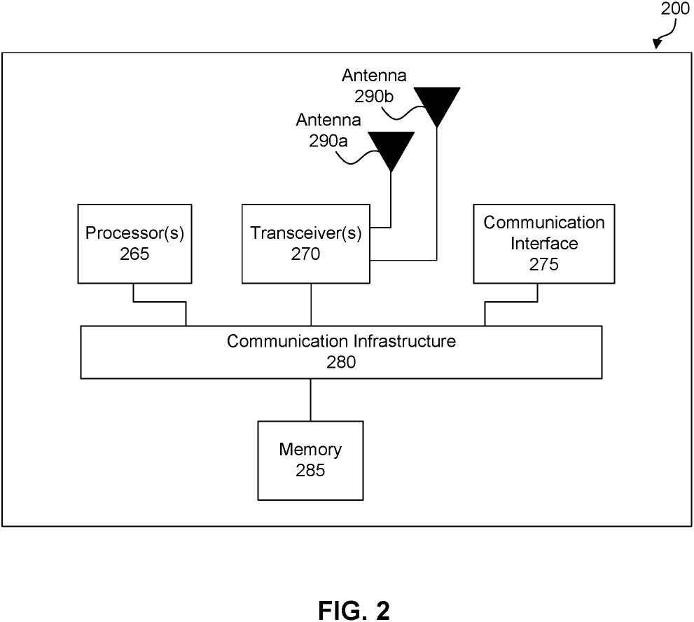

FIG. 2 illustrates a block diagram of example wireless system 200 supporting off-network multimodal interoperable communications, according to some embodiments of the disclosure. For explanation purposes and not a limitation, FIG. 2 may be described with reference to elements from FIG. 1. For example, system 200 may be any of the electronic devices (e.g., UE1 110, UE2 120, UE3 130, and UE4 140) of system 100. System 200 includes one or more processors 265, transceiver(s) 270, communication interface 275, communication infrastructure 280, memory 285, and antenna 290. Memory 285 may include random access memory (RAM) and/or cache, and may include control logic (e.g., computer instructions) and/or data. One or more processors 265 can execute the instructions stored in memory 285 to perform operations enabling wireless system 200 to transmit and receive wireless communications, including the functions for performing off-network multimodal interoperable communication functions herein. In some embodiments, one or more processors 265 can be “hard coded” to perform the functions herein. Transceiver(s) 270 transmits and receives wireless communications signals including wireless communications supporting off-network multimodal interoperable communications according to some embodiments, and may be coupled to one or more antennas 290 (e.g., 290a, 290b). In some embodiments, a transceiver 270a (not shown) may be coupled to antenna 290a and different transceiver 270b (not shown) can be coupled to antenna 290b. Communication interface 275 allows system 200 to communicate with other devices that may be wired and/or wireless. Communication infrastructure 280 may be a bus. Antenna 290 may include one or more antennas that may be the same or different types.

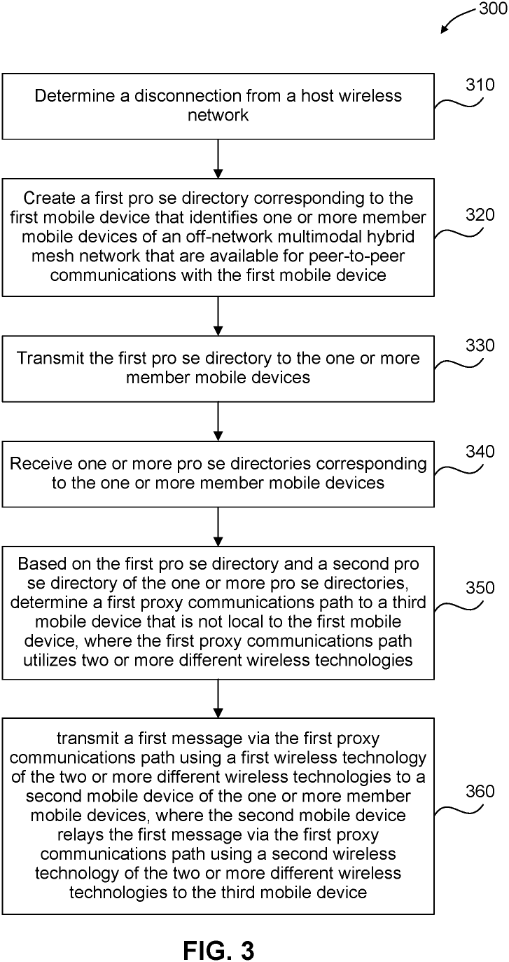

FIG. 3 illustrates example method 300 for off-network multimodal interoperable communications, in accordance with some embodiments of the disclosure. For explanation purposes and not a limitation, FIG. 3 may be described with reference to elements from FIGS. 1 and 2. For example, method 300 can be performed by system 200 of FIG. 2 or any of the electronic devices (e.g., UE1 110, UE2 120, UE3 130, and UE4 140) of system 100.

At 310, a first mobile device (e.g., UE1 110) determines that wireless signal 113 is lost (e.g., that UE1 110 is disconnected from a first host wireless network (e.g., host wireless network 1 115.)

At 320, based at least on the disconnection, UE1 110 can create a first pro se directory corresponding to UE1 110 that identifies one or more member mobile devices of off-network multimodal hybrid mesh network 150 that are available for peer-to-peer communications with the first mobile device (e.g., UE2 120 and UE4 140). The first mobile device is a member mobile device of off-network multimodal hybrid mesh network 150.

At 330, UE1 110 can transmit the first pro se directory to the one or more member mobile devices, UE2 120 and UE4 140.

At 340, UE1 110 can receive a second pro se directory from UE2 120 and another pro se directory from UE4 140 of the one or more member mobile devices, where UE2 120 is disconnected from a corresponding second host wireless network, host wireless network 2 125. In otherwords, wireless signal 123 is lost and UE2 120 cannot access host wireless network 2 125.

At 350, based on the first pro se directory and the second pro se directory, UE1 110 can determine a first proxy communications path to a third mobile device (e.g., UE3 130) that is not local to the first mobile device, UE1 110, where the third mobile device, UE3 130, has access to a third host wireless network, host wireless network 3 135 via wireless signal 133. In some embodiments, the first proxy communications path utilizes two or more different wireless technologies. UE1 110 can transmit a first message via the first proxy communications path using a first wireless technology to the second mobile device, UE2 120, where UE2 120 relays the first message via the first proxy communications path using a second wireless technology to the third mobile device, UE3 130, and onto host wireless network 3 135 and perhaps to internet 160.

In some embodiments, the second pro se directory indicates that UE3 130 is in proximity to UE2 120, and includes a relay status of the UE2 120 to relay signals to UE3 130. In some embodiments, to create the first pro se directory, UE1 110 can discover one or more local mobile devices (e.g., UE2 120 and UE4 140) available for peer-to-peer communications, and transmit invitations to the one or more local mobile devices, UE2 120 and UE4 140, to become members of off-network multimodal hybrid mesh network 150. In response to the invitations, UE1 110 can receive one or more acceptances corresponding to one or more member mobile devices, UE2 120 and UE4 140, of off-network multimodal hybrid mesh network 150 and create the first pro se directory corresponding to peer-to-peer communication abilities of UE1 110 based at least on the one or more acceptances. UE1 110 can transmit the first pro se directory to UE2 120 and UE4 140, and receive one or more pro se directories corresponding to UE2 120 and UE4 140 including the second pro se directory and the other pro se directory of UE4 140.

In some embodiments, the two or more different wireless technologies comprise: Specialized Land Mobile Radio Services (SMR), Advanced Wireless Service (AWS), Broadband Personal Communication Services, (PCS), General Mobile Radio Service (GMRS), Multi-Use Radio Service (MURS), LoRa, Cellular service, Citizens Band Radio Service (CB), Citizens Broadband Radio Service (CBRS), Bluetooth, WiFi, Low-Power Radio Service (LPRS), or Family Radio Service (FRS).

Other considerations when implementing some embodiments are as follows:

In some embodiments, there there may be an application module coupled to the first Mobile Device that periodically stores and records in the Pro Se Directory announcement or presence messages transmitted by other Mobile Devices and received by the first Mobile Device. There may be a signal repeater, signal amplifier, or beam forming module (a Signal Enhancer) coupled to a Mobile Device that is employed upon a loss of mobile wireless connectivity to the Host Network which amplifies a communication transmitted by the Mobile Device to other Mobile Devices over one or more other wireless protocols or frequencies at a signal strength greater that than the Mobile Device’s transmission power used for the host wireless network in the absence of the signal enhancer. There may be an antenna module (AM) coupled to a Mobile Device signal enhancer which may be include a dynamic phase array.

In some embodiments, there may be a computer program coupled to a Mobile Device that controls a signal enhancer coupled to it (a “Signal Enhancement Controller”), which may activate or deactivate the signal enhancer, and change signal power based using one or more programmatic rules and algorithms, including factors such as the signal strength, proximity, direction or location of other transceivers, and/or packet loss rate. In some embodiments, there may be a computer program coupled to a Mobile Device that controls an antenna coupled to the wireless transceiver (an “Antenna Controller”), which may send commands to an antenna to change its direction, phasing, filters, based upon one or more programmatic rules and algorithms including factors such as signal strength, proximity or location of other wireless mobile transceivers and packet loss rate. There may be signal power beacon function coupled to a Mobile Device which when disconnected from its host network transmits intermittent messages of its presence utilizing one or more discrete frequencies ad protocols.

In some embodiments, information about the configuration, operating state and performance characteristics of a Signal Enhancement Device or AM of a first Mobile Device may be transmitted to a second Mobule, and stored in a data store of the second Mobile Device’s Pro Se Directory. Some embodiments may include a module coupled to a first Mobile Device that is connected to a land mobile radio via a communications interface whereby if the first Mobile Device upon becoming disconnected from its host network transmits communications to the land mobile radio for relay through the activation of a radio transmission function, which may be effected through a voice activated exchange (VOX), COR or TOR relay signaling, or other signaling or radio command mechanism, where the communications interface between the land mobile radio transceiver may be two or four wire analog voice or tone signaling, Bluetooth, Wi-Fi or other signal receiver or port coupled to the land mobile radio transceiver.

In some embodiments, when in a disconnected host network state, there may be a mobile software application or module coupled to the first Mobile Device that is a notification module whereby a user may receive an audio modification or visual notification that another wireless Mobile Device is present upon receiving a second Mobile Device’s announcement or acknowledgement, is no longer present upon not receiving a second Mobile Device’s announcement or acknowledgement.

In some embodiments, there may be an artificial intelligence module coupled to a Mobile Device using the information stored in the various data stores of the system the predicted location of other Mobile Devices may be at a future time (t) and which are i proximate communications range of the Mobile Device. There may be as part of any collection of Mobile Devices of interest operating on a common host network one or more higher power end-user equipment devices, repeaters or access points (“HP Access Points”) that are coupled to autonomous or remote-controlled vehicle to which HP Access Devices are affixed or coupled that may move positions to maximize connections with the collection of Mobile Devices. The collection of mobile devices may be within a defined or proximately defined physical space established by a human or machine agent, or defined by the relative locations of a collection of Mobile Devices of interest. The maximization of connections can be determined based upon algorithms or rules taking into account various factors which may include, the priority, identity, purpose or functions of Various Mobile Devices, the content of messages, proximate coactivity to other HP Access Points and the collection of Mobile Devices connected to it. The the position of an HP Access Point may include environmental data such as elevations, contours, field obstacles and objects, atmospheric conditions and weather, where radio signal propagation and coverage is determined, and/or where physical terrain and accessibility in relation to the vehicle is determined using sensors, including LIDAR, machine vision, geo-position, geo-mapping and other data.

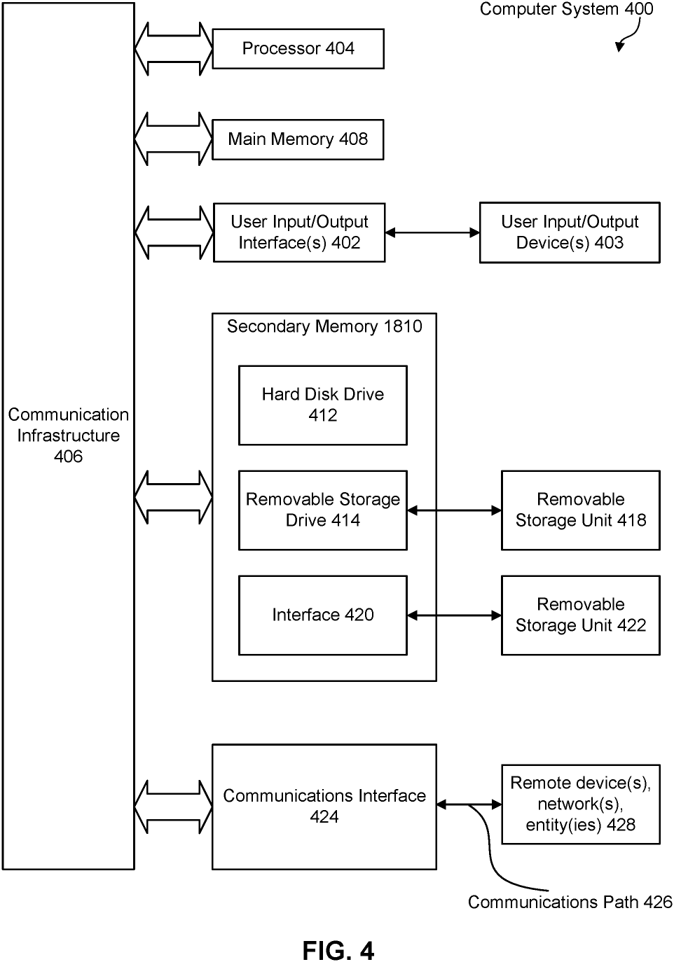

Various embodiments can be implemented, for example, using one or more well-known computer systems, such as computer system 400 shown in FIG. 4. Computer system 400 can be any well-known computer capable of performing the functions described herein. For example, and without limitation, UE1 110, UE2 120, UE3, 130, and UE4 140 of FIG. 1, system 200 of FIG. 2, method 300 of FIG. 3, and system 500 of FIG. 5 (and/or other apparatuses and/or components shown in the figures) may be implemented using computer system 400, or portions thereof.

Computer system 400 includes one or more processors (also called central processing units, or CPUs), such as a processor 404. Processor 404 is connected to a communication infrastructure 406 that can be a bus. One or more processors 404 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 also includes user input/output device(s) 403, such as monitors, keyboards, pointing devices, etc., that communicate with communication infrastructure 406 through user input/output interface(s) 402. Computer system 400 also includes a main or primary memory 408, such as random access memory (RAM). Main memory 408 may include one or more levels of cache. Main memory 408 has stored therein control logic (e.g., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/ any other computer data storage device. Removable storage drive 414 reads from and/or writes to removable storage unit 418 in a well-known manner.

According to some embodiments, secondary memory 410 may include other means, instrumentalities or other approaches for allowing computer programs and/or other instructions and/or data to be accessed by computer system 400. Such means, instrumentalities or other approaches may include, for example, a removable storage unit 44 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

What is claimed is:

1. A first mobile device, comprising:
a memory; and
a processor coupled to the memory, configured to:
determine a disconnection from a first host wireless network;
based at least on the disconnection, create a first pro se directory corresponding to the first mobile device that identifies one or more member mobile devices of an off-network multimodal hybrid mesh network that are available for peer-to-peer communications with the first mobile device, wherein the first mobile device is a member mobile device of the off-network multimodal hybrid mesh network;
transmit the first pro se directory to the one or more member mobile devices;
receive a second pro se directory from a second mobile device of the one or more member mobile devices, wherein the second mobile device is disconnected from a corresponding second host wireless network;
based on the first pro se directory and the second pro se directory, determine a first proxy communications path to a third mobile device that is not local to the first mobile device, wherein the third mobile device has access to a third host wireless network, and wherein the first proxy communications path utilizes two or more different wireless technologies; and
transmit a first message via the first proxy communications path using a first wireless technology of the two or more different wireless technologies to the second mobile device, wherein the second mobile device relays the first message via the first proxy communications path using a second wireless technology of the two or more different wireless technologies to the third mobile device.

2. The first mobile device, of claim 1, wherein the second pro se directory comprises: an indication that the third mobile device is in proximity to the second mobile device, and a relay status of the second mobile device to relay signals to the third mobile device.

3. The first mobile device of claim 1, wherein to create the first pro se directory, the processor is configured to:
discover one or more local mobile devices available for peer-to-peer communications;
transmit invitations to the one or more local mobile devices to become members of the off-network multimodal hybrid mesh network;
in response to the invitations, receive one or more acceptances corresponding to one or more member mobile devices of the off-network multimodal hybrid mesh network;
create the first pro se directory corresponding to peer-to-peer communication abilities of the first mobile device based at least on the one or more acceptances;
transmit the first pro se directory to the one or more member mobile devices; and
receive one or more pro se directories corresponding to the one or more member mobile devices including the second pro se directory.

4. The first mobile device of claim 1, wherein the two or more different wireless technologies comprise: Specialized Land Mobile Radio Services (SMR), Advanced Wireless Service (AWS), Broadband Personal Communication Services, (PCS), General Mobile Radio Service (GMRS), Multi-Use Radio Service (MURS), LoRa, Cellular service, Citizens Band Radio Service (CB), or Citizens Broadband Radio Service (CBRS).

5. The first mobile device of claim 1, wherein the two or more different wireless technologies comprise: Bluetooth, WiFi, Low-Power Radio Service (LPRS), or Family Radio Service (FRS).

6. The first mobile device of claim 1, wherein the processor is further configured to:
determine from an other pro se directory corresponding to a fourth mobile device of the one or more member mobile devices, an indication that the fourth mobile device in proximity has access to the third host wireless network;
set a relay status of the first mobile device for relaying signals to the fourth mobile device and the third host wireless network;
update the first pro se directory with the indication and the relay status; and
transmit the first pro se directory to the one or more member mobile devices.

7. The first mobile device of claim 6, further comprising a wireless local relay module (LRM) coupled to the processor, wherein the processor is further configured to:
receive a second message from a member mobile device of the one or more member mobile devices based on a second proxy communications path; and
based at least on the relay status, transmit the second message via the LRM to the fourth mobile device.

8. The first mobile device of claim 7, further comprising a land mobile radio interface coupled to the processor, wherein the second message is received via the land mobile radio interface, and wherein the transmission of the second message utilizes Bluetooth or Wi-Fi.

9. The first mobile device of claim 1, wherein to transmit the first message via the first proxy communications path using the first wireless technology, the processor is further configured to:
determine based on programmatic rules and algorithms, a first signal strength of the first message wherein the first signal strength is greater than a signal strength permitted for communications on the first host wireless network; and
transmit the first message using the first signal strength.

10. The first mobile device of claim 1, wherein to transmit the first message via the first proxy communications path using the first wireless technology, the processor is further configured to change: an antenna direction, an antenna phasing, or an antenna filter.

11. The first mobile device of claim 10, wherein the change is based on programmatic rules, algorithms and a factor comprising: a location of the second member mobile device corresponding to the first proxy communications path.

12. The first mobile device of claim 1, wherein the first mobile device corresponds to a first identification (UID) that can be transmitted in the first message and relayed along the first proxy communications path, wherein the first UID is unique and distinct from other UIDs of the one or more member mobile devices.

13. The first mobile device of claim 12, wherein the first mobile device is associated with one or more other identities that are relationally associated to the UID, wherein the one or more other identities are associated with: the first host wireless network (Network ID), an application operating on the first mobile device, a user of the application, or a user of the first mobile device.

14. The first mobile device of claim 13, wherein the processor is further configured to:
store data in the memory, wherein the data comprises: the UID, the Network ID, a user name, a password, a key, a token, or a network routing address associated with the Network ID, the first pro se directory, or one or more pro se directories corresponding to the one or more member mobile devices.

15. The first mobile device of claim 1, wherein the first pro se directory comprises: a unique identification (UID) of the first mobile device; a time, date, and location of the first mobile device; a user identity or network user identity for a distinct network; a routing address or proxy network address to the first mobile device; a data transmission rate; a communications protocol; encryption keys; a signal strength; a battery or power source; an organizational association; an end-user identity; a network host connectivity status including internet access or internet gateway access; or uplink and downlink data rates.

16. The first mobile device of claim 1, wherein the processor is further configured to:
receive a second message comprising updated routing and network connectivity status corresponding to the second pro se directory;
update the first pro se directory based on the second message; and
transmit a third message comprising updated routing and network connectivity status corresponding to the first pro se directory to the one or more member mobile devices.

17. The first mobile device of claim 1, further comprising a graphical user interface (GUI), wherein the GUI enables a selection that can change signal transmitting power or an antenna orientation to maximize a signal strength of the transmission of the first message to the second mobile device.

18. The first mobile device of claim 1, wherein the processor is further configured to:
determine locations of the one or more member mobile devices using location algorithms comprising: a time difference of arrival, an angle of arrival, or geo-position system data received from the one or more member mobile devices.

19. The first mobile device of claim 18, wherein the processor is further configured to:
determine a movement direction, speed, or anticipated location of the one or more member mobile devices based on a time series or sampling intervals of the determined locations.

20. The first mobile device of claim 19, wherein the first proxy communications path, is based at least on the movement direction, the speed, or the anticipated location of the one or more member mobile devices.

21. The first mobile device of claim 19, wherein the processor is configured to:
use the determined movement direction, speed, or anticipated location of the one or more member mobile devices to affect a direction of an antenna transmitting the first message or affect a transmission power of the first message.

22. The first mobile device of claim 1, wherein the determination of the first proxy communications path, the processor is configured to:
determine a priority proxy communications path comprising: a subset of the one or more member mobile devices, an antenna operating configuration, and a signal enhancement configuration based on a set of rules or algorithms; and
route through one or more member mobile device relays of the subset based on: a common or shared organizational membership, a communications encryption method or scheme, an attention method, an attention scheme, a network membership with the one or more member mobile device relays, a user associated with a member mobile device of the one or more member mobile device relays, or a user of a member mobile device relay of the one or more member mobile device relays, or a wireless network identity.

23. The first mobile device of claim 22, wherein the first message comprises a priority message relay that is re-transmitted, relayed, or received at a higher priority over other messages.

24. The first mobile device of claim 23, wherein the processor is configured to:
determine the priority message relay using a set of rules or algorithms based upon: a message type, a message content, an identity of the first mobile device or the third mobile device, an identity of a first user of the first mobile device or a second user of the third mobile device, or an organizational role or function of the first user or the second user.
